(19) United States
(12) Patent Application Publication
(10) Pub. No.: US 2005/0029314 A1
(43) Pub. Date: Feb. 10, 2005

(54) Flexible nozzle extension

(75) Inventors: Rosalyn J. Williams, Severna Park, MD (US); George Jeffery Mowry, Mesa, AZ (US)

Correspondence Address: WOOD, HERRON & EVANS, LLP, 2700 CAREW TOWER, 441 VINE STREET, CINCINNATI, OH, 45202, US

(73) Assignee: DAP Products Inc.

(21) Appl. No.: 10/637,201

(22) Filed: Aug. 8, 2003

(51) Int. Cl. G01F 11/30

(52) U.S. Cl. 222/527; 222/327; 222/391; 222/567

(57) ABSTRACT

A flexible extender nozzle that can be used in conjunction with a variety of different caulk cartridges and caulking guns. The flexible extender nozzle has a flange which is adapted to allow the extender nozzle to be operably sandwiched between the caulk cartridge and the caulking gun. The flexible extender nozzle also contains a raised seal ring which is adapted to form a seal on a variety of cartridges.

### FIELD OF INVENTION

The present invention relates to nozzles for use with containers in general, and more particularly to flexible nozzles for extending and adjusting the dispersion of caulk or other materials from a cartridge.

### BACKGROUND

Containers, cartridges, or tubes containing caulk for use in a variety of applications such as to create seals around windows, doors, siding, or tile, are well known. A typical caulk container or cartridge is comprised of a cylindrical tube with a nozzle or dispensation tube attached at the discharge end of the cartridge. Discharge ends of cartridges come in a variety of configurations. For example, some have rounded shoulders, some have rims, some have partial rims, some have angled rims, some have rims with fingers, and some have inner raised surfaces. The opposite end of the cartridge or tube contains a plunger or push pad. When the cartridge is placed in a caulking gun, the ramrod of the caulking gun is advanced against the plunger or push pad to force caulk out the nose or nozzle of the cartridge.

Caulking guns come in two main types, one being a top loaded gun whereby the cartridge is placed in a generally U-shaped open-top chamber in the gun, or a skeleton-type caulking gun whereby the cartridge is side loaded into the gun. The top loading gun has a front wall with a generally U-shaped aperture which allows the nozzle of the cartridge to operably extend through while still securing the cartridge cylinder. The skeleton-type caulking gun has either a U-shaped aperture or a front rim which allows the nozzle of the cartridge to operably extend through while still securing the cartridge cylinder.

In many caulking applications, caulk is desired to be applied in hard to reach locations, such as around the base portion of a toilet. In such applications maneuvering a caulking gun to place the tip of the cartridge's nozzle at the location where caulk is desired can be extremely difficult if not altogether impossible.

To address this situation, some attempts have been made to extend the nozzle of the caulk cartridge. However, difficulties can arise as different caulk cartridges have different shoulder configurations. Accordingly, there is a need to be able to apply caulk in hard to reach spots regardless of what style caulk cartridge is being used, and regardless of what style caulking gun is being employed.

### OBJECTS OF THE INVENTION

It is an object of the present invention to allow for the dispensation of caulk in locations that are hard to reach. It is also an object of the present invention to provide a nozzle adapter for use with a plurality of caulk cartridges or tubes, as well as a variety of caulking guns.

### SUMMARY OF THE INVENTION

The present invention provides for a flexible extender nozzle that can be used in conjunction with a variety of different caulk cartridges and caulking guns. The flexible extender nozzle has a flange which is adapted to allow the extender nozzle to be operably sandwiched between the caulk cartridge and the caulking gun. The flexible extender nozzle also contains a raised seal ring which is adapted to form a seal on a variety of cartridges.

The above and other objects and advantages of the present invention shall be made apparent from the accompanying drawings and the descriptions thereof.

### BRIEF DESCRIPTION OF DRAWINGS

The accompanying drawings which incorporate and constitute a part of this specification, illustrate embodiments of the invention and, together with a general description of the invention given above and the detailed description given below, serve to explain the principles of the invention.

FIG. 1 is a side view of a caulking gun, a caulk cartridge and an extendable nozzle according to the principles of the present invention.

FIG. 2 is a perspective view of an extender nozzle according to the principles of the present invention used in conjunction with the caulking gun shown in FIG. 1.

FIG. 3 is a perspective view of an extender nozzle according to the principles of the present invention used with an alternative caulking gun.

FIG. 4 is a is a perspective view of the extender nozzle shown in FIG. 1.

FIG. 5 is an end view of the extender nozzle shown in FIG. 4.

FIG. 6 is an end view of an alternative embodiment of the extender nozzle shown in FIG. 5.

FIG. 7 is a perspective view of a portion of the extender nozzle shown in FIG. 4 being placed over the nose or nozzle of a caulk cartridge.

FIG. 8 is a cross-section view of the extender nozzle, cartridge, and caulk gun shown in FIG. 1.

FIG. 9 is a cross-section view of an extender nozzle according to the present invention used in conjunction with an alternative caulk cartridge.

FIG. 10 is a cross-section view, similar to FIG. 9, showing a flexible extender nozzle according to the principles of the present invention used in conjunction with an alternative caulk cartridge.

FIG. 11 is a cross-section view, similar to FIGS. 9 and 10, showing a flexible extender nozzle according to the principles of the present invention used in conjunction with an alternative caulk cartridge.

FIG. 12 is a cross-section view, similar to FIGS. 9-11, showing a flexible extender nozzle according to the principles of the present invention used in conjunction with an alternative caulk cartridge.

### DETAILED DESCRIPTION

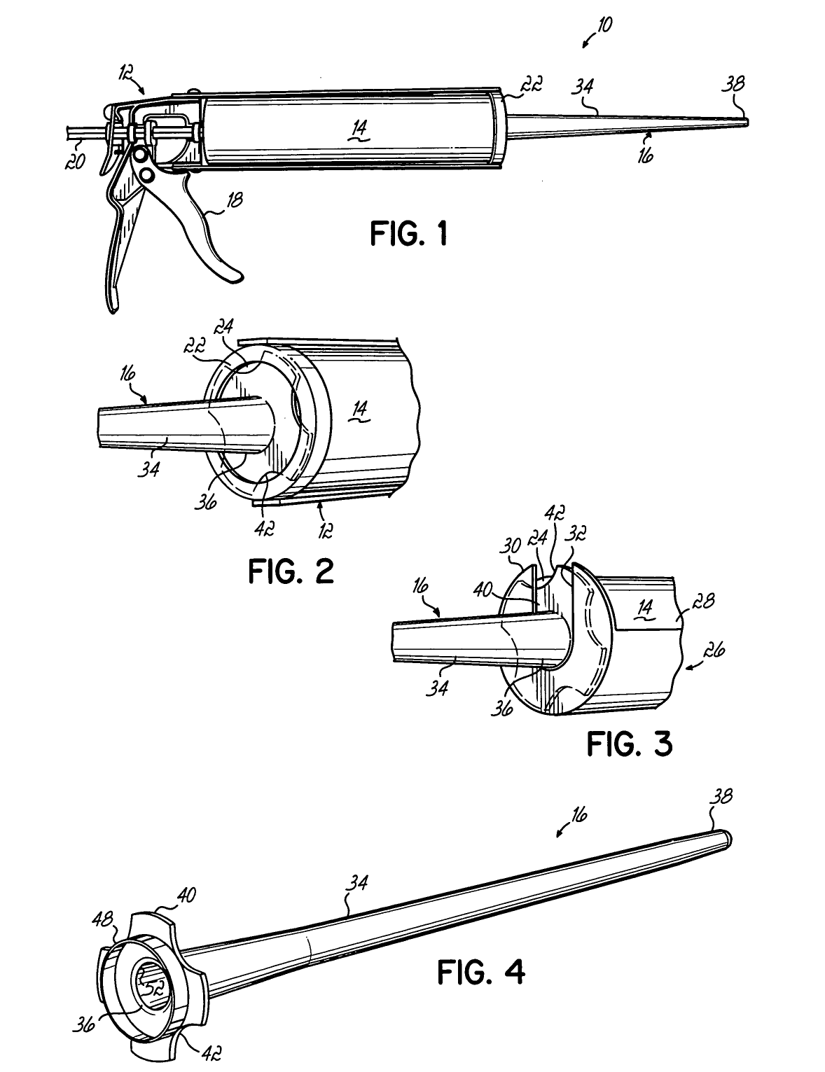

Referring to the figures and to FIG. 1 in particular, a system 10 for dispensing a material such as caulk is shown. The system 10 includes a dispenser or caulking gun 12, a container, cartridge, tube or canister 14 which holds caulk or other like material (not shown), and an extender nozzle 16. The caulking gun 12 has a handle or trigger 18 which when squeezed, advances a ramrod or plunger or 20 forward against a push pad or plunger (not shown) of the cartridge 14. This in turn forces caulk out cartridge 14 and through the extender nozzle 16.

The skeleton-type caulking gun 12 shown in FIG. 1 and partially in FIG. 2 has a front rim 22 which allows the extender nozzle 16 to operably extend through while still securing the discharge end or shoulder 24 of the cartridge 14. FIG. 3 partially shows an alternative caulking gun 26 with a U-shaped open-top chamber 28 which allows for a cartridge 14 to be top loaded in the gun 26. The top loading gun 26 has a front wall 30 with a generally U-shaped aperture 32 which allows the extender nozzle 16 to operably extend through while still securing the discharge end or shoulder 24 of the cartridge 14. In both guns 12, 26 the extender nozzle 16 is operably sandwiched between the respective guns 12, 26 and the caulk cartridge 14.

One embodiment of the extender nozzle 16 is further shown in FIG. 4. As shown, this extender nozzle 16 is comprised of a tube 34 with a proximal end portion 36 and a distal end portion or tip 38 through which caulk is dispensed. The tube 34 is generally tapered, with a wider portion at the proximal end portion 36 and the narrower portion at the distal end portion or tip 38. If desired, the tip 38 can be trimmed by a user to allow for a wider bead of caulk. Typically, the extender nozzle 16 will be comprised of injection molded plastic, which will allow the tube 34 to be flexed and bent or adjusted as needed for the dispensation of caulk in otherwise hard to reach locations.

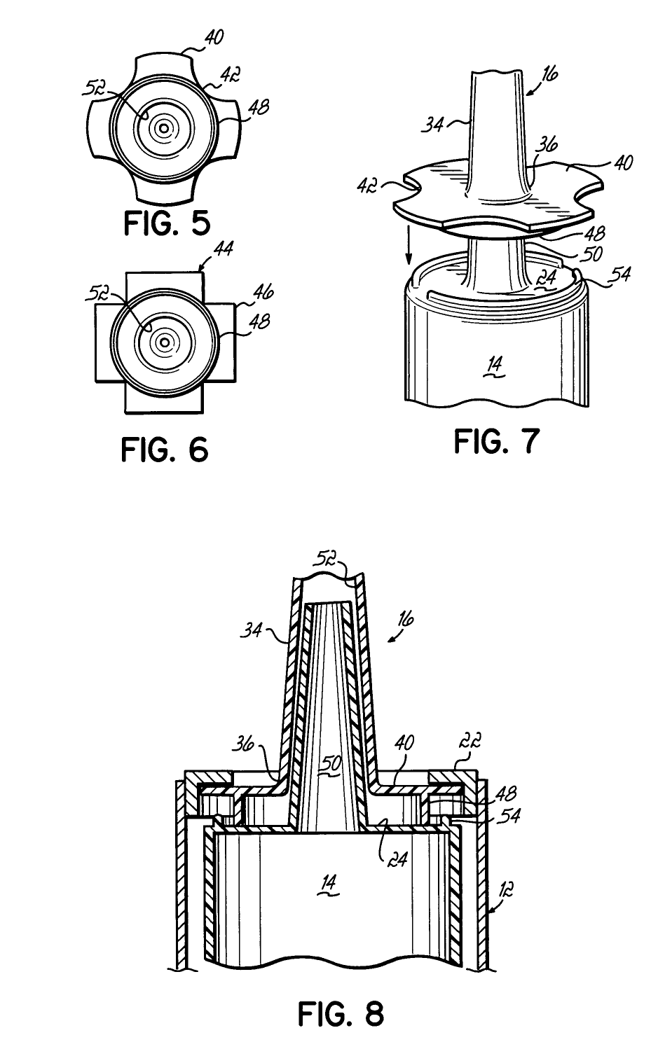

The extender nozzle 16 also includes a flange 40 which is attached to the distal portion 36 of the tube 34. As is also shown in FIG. 5, the flange 40 is scalloped with a plurality of concave portions 42. However, as shown in FIG. 6, flange 44 in alternative embodiments may be comprised of straight extended arms 46. Other embodiments may also include other styles of angular flanges. In any embodiment however, the flange will be of a sufficient configuration to withstand the pressure that is applied during the caulking process.

Finally, the extender nozzle 16 includes a raised, annular seal ring 48 which is positioned inwardly of the deepest depression of the concave portions 42 of the flange 40. This seal ring 48 is of a sufficient height to operably make contact with the shoulder 24 of the cartridge 14 regardless of the specific configuration of the shoulder end 24 of the cartridge 14.

As shown in FIG. 7, the cartridge 14 has a nozzle or discharge tube 50 which extends away from the discharge end or shoulder 24. The tube 34 of the extender nozzle 16 has an inner diameter 52 which is sized to allow the extender nozzle 16 to be placed over the nozzle 50 of the cartridge 14. The raised seal ring 48 of the extender nozzle 16 contacts and operably creates a seal with the shoulder 24 of the cartridge 14. As shown in FIG. 7, the raised seal ring 48 will form a seal with this cartridge 14, even though it has a partial raised rim 54 extending from the shoulder 24 of the cartridge 14.

FIG. 8 shows how the raised seal ring 48 forms a seal with the shoulder 24 of the cartridge 14. The flange 40 and the raised seal ring 48 of the extender nozzle 16 are sandwiched between the front rim 22 of the caulking gun 12 and the shoulder 24 of the cartridge 14. As the ramrod 20 advances, it will not only force caulk through the extender nozzle 16, put will also push the cartridge 14 against the extender nozzle 16 and in turn against the front rim 22, or in the case of top loaded gun 26 (FIG. 3), the front wall 30.

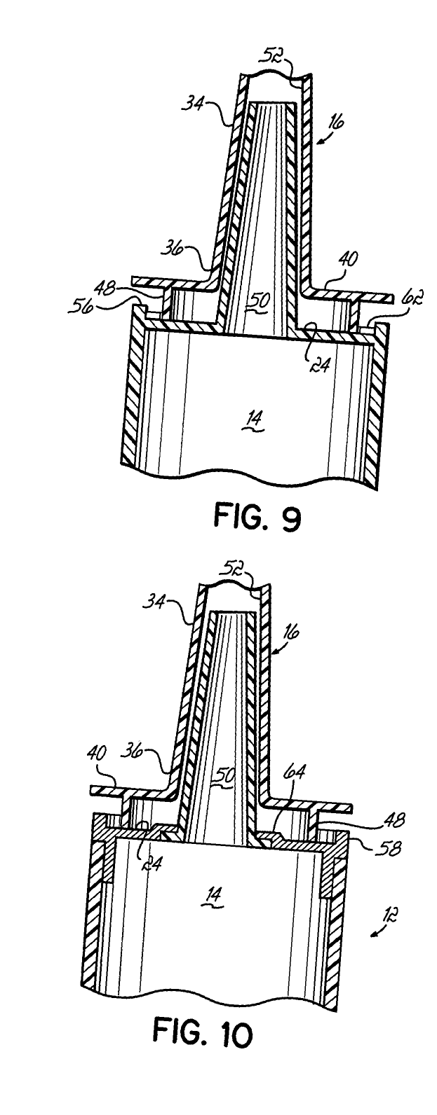

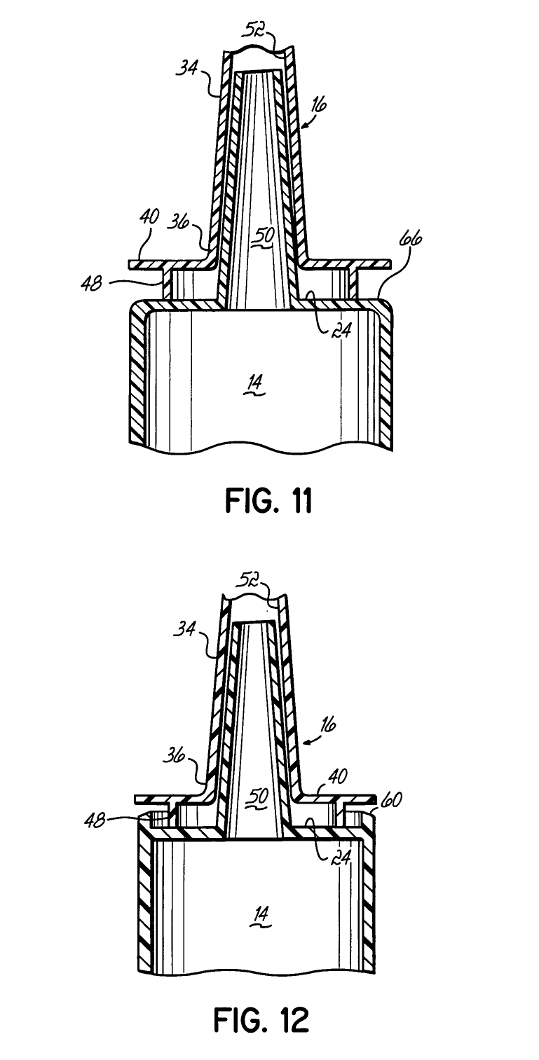

As further illustrated in FIGS. 9-11, the raised seal ring 48 is positioned at a radial point and at a sufficient height to create a seal on a plurality of caulk cartridges 14 with a variety of shoulder 24 configurations. For example, the seal ring 48 is of a sufficient height to create a seal regardless of the height or configuration of the respective shoulder rims 54, 56, 58, 60 (FIGS. 8-10 and 12). Also, as shown in FIG. 9, the seal ring 48 is radially spaced so as to lie within any fingers or projections 62 that may inwardly extend from the rim 56. The seal ring 48 is also adapted, as shown in FIG. 10, to form a seal with cartridges 14 that have raised portions 64 near the nose or nozzle 50 of the cartridge 14. Finally, as shown in FIG. 11, the seal ring 48 functions equally with cartridges 14 that have no shoulder rims or those with a rounded shoulder 66.

In operation, a user would first open a caulk cartridge 14 by typically cutting the end of the cartridge's nose or nozzle 50 or by puncturing its inner seal (not shown) if required. Second, the distal end or tip 38 of the extender nozzle 16 would, if desired, be trimmed or enlarged to provide for a wider bead of caulk. Next, the extender nozzle 16 is slid over the nose or nozzle 50 of the caulk cartridge 14 and the extender nozzle 16 and caulk cartridge 14 are placed into a caulking gun 12. The trigger 18 of the caulking gun 12 is then squeezed as required to dispense caulk through the extender nozzle 16. The user positions the distal end 38 of the flexible extender nozzle 16 at the desired location for the application of the caulk.

This has been a description of the present invention along with the preferred mode of practicing the invention. However, the invention itself should only be defined by the appended claims wherein we claim:

1. An apparatus for adjusting the dispensation of material from a container when said container is supported by a dispenser comprising:
a tube having an inner diameter, a proximal end portion and a distal end portion, said proximal end portion adapted to receive said material from said container, said distal end portion adapted to dispense said material;
a flange attached to said proximal end portion of said tube, said flange operably sandwiched between said container and said dispenser, said flange adapted to keep said apparatus in contact with said container during said dispensation of said material from said container; and
a raised seal having a perimeter, said seal attached to said flange, said seal adapted to seal said apparatus against said container during said dispensation of said material from said container.

2. The apparatus of claim 1 wherein said tube is flexible.

3. The apparatus of claim 1 wherein said inner diameter of said tube is sized to operably permit at least a portion of said container to be positioned within said tube.

4. The apparatus of claim 1 wherein said tube has a variable inner diameter.

5. The apparatus of claim 1 wherein said tube is tapered.

6. The apparatus of claim 4 wherein said proximal end portion of said tube is wider than said distal end portion of said tube.

7. The apparatus of claim 1 wherein said flange is comprised of a plurality of radially extending arms.

8. The apparatus of claim 1 wherein said flange is scalloped, said scalloped flange having a plurality of concave portions.

9. The apparatus of claim 8 wherein said concave portions of said scalloped flange do not inwardly extend inside said perimeter of seal.

10. The apparatus of claim 1 wherein said flange has a diameter and said container has an exterior diameter, and wherein said diameter of said flange is less than said exterior diameter of said container.

11. The apparatus of claim 1 wherein said seal is a raised ring that extends away from said flange and away from said proximal end portion of said tube.

12. The apparatus of claim 11 wherein said flange has a diameter and said seal has an exterior diameter, and wherein said diameter of said flange is greater than said exterior diameter of said seal.

13. A plastic apparatus for adjusting the dispensation of caulk from the nozzle of a cylindrical caulk cartridge when said cartridge is supported by a caulk gun comprising:
a flexible tapered dispensation tube having an inner diameter, a proximal end portion and a narrower distal end portion, said inner diameter of said tube being sized to operably permit said nozzle of said cartridge to be positioned within said tube, said proximal end portion of said tube adapted to receive said caulk from said nozzle of said cartridge, said distal end portion of said tube adapted to dispense said caulk;
a scalloped flange attached to said proximal end portion of said tube, said flange having a plurality of concave portions, said flange operably sandwiched between said cartridge and said gun, said flange adapted to keep said apparatus in contact with said cartridge during said dispensation of said caulk from said cartridge; and
a raised seal ring having a perimeter, said seal ring attached to said flange and extending away from said flange and said proximal end portion of said tube, said seal ring adapted to seal said apparatus against said caulk container during said dispensation of said caulk from said caulk container.

14. The apparatus of claim 13 wherein said concave portions of said scalloped flange do not extend inside said perimeter of said seal.

15. The apparatus of claim 13 wherein said flange has a diameter and said cartridge has an exterior diameter, and wherein said diameter of said flange is less than said exterior diameter of said cartridge.

16. The apparatus of claim 13 wherein said flange has a diameter and said seal has an exterior diameter, and wherein said diameter of said flange is greater than said exterior diameter of said seal.

17. A system for dispensing material comprising:
a container containing said material for dispensing;
a flexible extender nozzle having a tube, a flange, and a raised seal, said extender nozzle adapted to promote elongated dispensation of said material from said container; and
a dispenser adapted to operably support said container and said extender, said dispenser also adapted to operably create a sealable contact between said container and said extender.

18. The system of claim 17 wherein said container is a cylindrical caulk cartridge.

19. The system of claim 17 wherein said flange is scalloped.

20. The system of claim 17 wherein said seal is a raised ring that extends away from said flange whereby a sealable contact is operably created between said extender nozzle and said container.

21. The system of claim 17 wherein the dispenser is a caulk gun.

22. An elongated tube having inner and outer diameters and proximal and distal ends,
a flange projecting radially outwardly of said tube adjacent said proximal end thereof and having an upper surface facing toward said tube distal end and a lower surface facing away from said tube distal end, and
an annular sealing ring mounted on said lower surface of said flange and projecting away therefrom.

23. The flexible nozzle extension of claim 22 wherein:
said flange has a scalloped configuration

24. The flexible nozzle extension of claim 23 wherein:
said scalloped configuration of said flange includes a plurality of concave portions; and
inner extremities of said concave portions are disposed outwardly of said annular sealing ring.

25. The flexible nozzle extension of claim 22 wherein:
said elongated tube is substantially uniformly tapered inwardly from adjacent said proximal to said distal end thereof.

26. The flexible nozzle extension of claim 22 wherein:
said tube, said flange and said annular sealing ring are formed of one piece molded construction.

27. A flexible nozzle extension comprising:
an elongated tube having inner and outer diameters and proximal and distal ends and tapering uniformly inwardly from adjacent said proximal end to adjacent said distal end thereof;
a flange having a scalloped configuration and projecting radially outwardly of said tube adjacent said proximal end thereof and having an upper surface facing toward said distal end of said tube and a lower surface facing away from said distal end of said tube;
an annular sealing ring mounted on said lower surface of said flange and projecting away therefrom,
said scalloped configuration including a plurality of concave portions with inner extremities of said portions being disposed outwardly of said annular sealing ring; and
and said tube, said flange and said annular sealing ring being form integrally of a flexible plastic material.
